(19) United States
(12) Patent Application Publication
(10) Pub. No.: US 2019/0390706 A1
(43) Pub. Date: Dec. 26, 2019

(54) BALL JOINT

(71) Applicant: ZF Friedrichshafen AG, Friedrichshafen (DE)

(72) Inventor: Jürgen GRÄBER, Stemwede (DE)

(21) Appl. No.: 16/481,514

(22) PCT Filed: Feb. 9, 2018
(86) PCT No.: PCT/EP2018/053243

§ 371 Date: Jul. 29, 2019

(30) Foreign Application Priority Data
Mar. 7, 2017 (DE) 10 2017 203 711.3

(51) Int. Cl. F16C 11/06

(52) U.S. Cl. CPC F16C 11/0638; F16C 2229/00; F16C 2326/05

(57) ABSTRACT

A ball joint with a housing having a housing opening with which a central axis (5) extending in an axial direction (z) and emerging through the housing opening is associated. A ball journal (12) having a joint ball (11) which, with its joint ball (11), is fitted and able to move within the housing and which extends out of the housing through the housing opening. A locking ring (13) is securely fitted into the housing which surrounds the central axis (5) and supports the joint ball (11) in the axial direction (z). The ring delimits a locking ring opening (25) through which the ball journal (12) extends, such that the locking ring opening (25) is larger, in a longitudinal direction (x), that extends transversely to the central axis (5) than in a transverse direction (y), that extends transversely to the central axis (5) and to the longitudinal direction (x).

This application is a National Stage completion of PCT/EP2018/053243 filed Feb. 9, 2018, which claims priority from German patent application serial no. 10 2017 203 711.3 mailed Mar. 7, 2017.

### FIELD OF THE INVENTION

The invention relates to a ball joint, with a housing that has a housing opening with which a central axis extending in an axial direction and passing through the housing opening is associated, a ball journal having a joint ball, which is fitted with its joint ball able to move in the housing, and which extends out of the housing through the housing opening, and a locking ring fixed securely in the housing, which ring surrounds the central axis and supports the joint ball in the axial direction, the ring delimiting a locking ring opening through which the ball journal extends.

### BACKGROUND OF THE INVENTION

Such a ball joint is used for example in the chassis of a motor vehicle, and is known for example from DE 10 2015 211 005 A1.

For the support of the joint ball, the locking ring overlaps the joint ball and/or a ball socket that holds the joint ball in the axial direction. This overlap is the smaller, the larger is the desired deflection of the ball journal relative to the housing, so that with the ball joint unchanged in other respects, the ability to be deflected by a larger amount entails a lesser ability to support the ball joint axially. Thus, the overlap reduction reduces the load-bearing ability of the ball joint in the axial direction. To compensate for this reduced load-bearing ability, the ball joint is often made larger. However, a larger joint is undesired since the fitting space in motor vehicles is restricted. Moreover, a larger joint increases the weight of the motor vehicle and hence its fuel consumption. Finally, due to the increased use of material alone, making the joint larger increases the manufacturing costs of the joint.

### SUMMARY OF THE INVENTION

Starting from there the purpose of the present invention is to be able to increase the axial load-bearing ability of a ball joint of the type mentioned at the start, without making the joint significantly larger.

This objective is achieved by a ball joint according to the independent claim(s). Preferred further developments of the ball joint are indicated in the subordinate claims and in the description that follows.

The ball joint mentioned at the start, with a housing that has a housing opening with which a central axis extending in an axial direction and passing through the housing opening is associated, a ball journal having a joint ball, which is fitted with its joint ball able to move in the housing, and which extends out of the housing through the housing opening, and a locking ring fixed securely in the housing, which ring surrounds the central axis and supports the joint ball in the axial direction, the ring delimiting a locking ring opening through which the ball journal extends, is in particular further developed in that in a longitudinal direction transverse to the central axis the locking ring opening is made larger than in a transverse direction extending perpendicularly to the central axis and to the longitudinal direction.

This makes it possible to obtain the desired deflection ability of the ball journal relative to the housing in the longitudinal direction, whereas in contrast in the transverse direction the axial overlap and hence the axial load-bearing ability of the ball joint are increased. This is possible because in many practical applications the deflection of the ball journal relative to the housing is a maximum only in one direction, but is much smaller in other directions. Thus, it is not necessary to have a circular locking ring.

The increased axial overlap in the transverse direction leads in particular to an additional area segment which is available for axial support, so that the surface pressure in the axial direction can be reduced. Advantageously, this also results in less wear. The additional area segment is also, in particular, advantageous for measuring the spring rigidity in accordance with wear tests and can if necessary also be regarded as an additional adjustment element. Although it is true that due to the non-circular locking ring opening the ball joint as a rule has to be fitted in a particular orientation and/or direction, this is acceptable considering the space, weight and cost advantages. In particular, the directional fitting should present no problem in the case of an integrated support joint, even when the fitting is carried out purely by friction.

Preferably, the central axis passes through the mid-point of the joint ball. In particular, a direction or any direction perpendicular to the central axis and/or to the axial direction is called a radial direction.

The housing preferably has an inner housing space. Preferably, the ball journal with its joint ball is fitted and able to move in the inner housing space. Advantageously, the inner housing space merges into the housing opening, particularly in the axial direction.

The locking ring is seated for example in the housing opening and/or in the inner housing space. Preferably, the locking ring is located in an area of the inner housing space that faces toward the housing opening. For example, the locking ring is positioned, specifically in the axial direction, between the joint ball and the housing opening. Preferably, particularly in the axial direction the locking ring is located between the joint ball and an inner shoulder of the housing provided in particular in the area of the housing opening. Advantageously, the locking ring is supported in the axial direction on the inner shoulder. Preferably the locking ring rests, preferably on an end facing away from the joint ball, against the inner shoulder, specifically in the axial direction. The inner shoulder is preferably annular.

Preferably the locking ring overlaps the joint ball in the axial direction. Preferably the locking ring opening, for example in a ring plane perpendicular to the central axis, is oval and/or elliptical and/or in the shape of an elongated hole. Preferably the projection of the locking ring opening on a projection plane perpendicular to the central axis is oval and/or elliptical and/or in the shape of an elongated hole. Advantageously, the central axis passes through the middle of the housing opening and/or the locking ring opening. The housing opening is preferably larger than the locking ring opening. Preferably, in the axial direction the locking ring opening and the housing opening are arranged one behind the other and/or one after the other. Advantageously, in the axial direction the locking ring opening is located between the joint ball and the housing opening.

In one embodiment the housing has a housing rim that delimits the housing opening, which rim is preferably bent inward and/or preferably encloses the locking ring in the axial direction. Thus, in the axial direction the locking ring is in particular secured in the housing with interlock. The bending over of the housing rim preferably takes place by pressure-loaded rollers and is therefore also known as rolling. In particular, the inner shoulder is formed by the housing rim bent inward.

According to an embodiment the end face of the locking ring facing away from the joint ball lies in an end-face plane transverse to the central axis, which for example is also called the outer end plane. This has the advantage that conventional techniques for dosing the ball joint can be used, such as rolling.

In a further development, in particular relatively to the central axis the outer circumferential surface of the locking ring is rotationally-symmetrical and/or circular and/or circular-cylindrical. Preferably, this applies to the whole axial extension of the locking ring. Thus for example, it is possible for the housing opening and/or the inner housing space and/or the area of the inner housing space facing toward the housing opening to be made rotationally-symmetrical relative to the central axis, which has cost advantages for the production of the housing. Preferably, in particular relative to the central axis, the housing opening and/or the inner housing space and/or the area of the inner housing space facing toward the housing opening is/are rotationally-symmetrical and/or circular and/or circular-cylindrical. The outer circumferential surface of the locking ring is preferably in contact with an inner circumferential surface of the housing. In particular relative to the central axis, this inner circumferential surface of the housing is rotationally-symmetrical and/or circular and/or circular-cylindrical. Preferably, this inner circumferential surface of the housing is located in the housing opening and/or the inner housing space and/or the area of the inner housing space facing toward the housing opening.

According to a further development, the joint ball is fitted into the housing, in particular movably, with a ball socket interposed between them. Preferably the joint ball fits into the ball socket in particular so that it can slide. Advantageously, the ball socket is arranged in the inner housing space. The ball journal with its joint ball is preferably fitted into the housing and/or the ball socket in such manner that it can pivot. Advantageously, the ball journal with its joint ball is fitted into the housing and/or the ball socket so that it can rotate and/or be deflected. Preferably, the ball socket consists of plastic, in particular a thermoplastic material. For example, the plastic has no fibers. Alternatively, the plastic is for example mixed or reinforced with fibers, for example including glass fibers. Advantageously, in particular relative to the central axis the ball socket is rotationally-symmetrical.

Preferably, specifically on its side facing toward the housing opening, the ball socket has a ball socket opening through which the ball journal extends outwards, in particular out of the ball socket. Advantageously, the ball socket has an overlap area that surrounds and/or delimits the ball socket opening, which overlaps the joint ball in the axial direction. Preferably, relative to the central axis the overlap area is inclined inward toward the housing opening. In particular, the overlap area is overlapped by the locking ring in the axial direction. Advantageously, the central axis passes in particular through the center of the ball socket opening.

Preferably, particularly in the axial direction the locking ring is positioned between the ball socket and the housing opening. Preferably, particularly in the axial direction the locking ring is positioned between the ball socket and the inner shoulder of the housing. Advantageously, in the axial direction the ball socket is supported on the locking ring. Preferably, in or with its overlap area and in particular in the axial direction the ball socket lies on the locking ring. Advantageously, the overlap area together with the, or with an inner circumferential surface of the housing, delimits an annular space. Preferably, in the axial direction the annular space is bounded by the inner shoulder. Preferably the annular space is located in the inner housing space. In particular, the locking ring is arranged in the annular space and/or the locking ring is seated specifically in the annular space. Preferably the annular space is wedge-shaped in cross-section. In particular, a side of the annular space facing toward the ball socket and/or a side of the annular space defined by the ball socket is straight in cross-section. Alternatively, the side of the annular space facing toward the ball socket and/or a side of the annular space defined by the ball socket can be curved in cross-section, specifically curved inward.

In an embodiment the locking ring has an annular area facing away from the joint ball and an annular area facing toward the joint ball. In particular, each of the annular areas is ring-shaped. Preferably, the annular area facing toward the joint ball has an inner circumferential surface surrounding the central axis. Advantageously, and particularly relative to the central axis, this inner circumferential surface is rotationally-symmetrical. Preferably, the annular area facing toward the joint ball has the, or has an inner circumferential surface which in particular is rotationally-symmetrical relative to the central axis. In cross-section the inner circumferential surface can be made straight or curved, in particular curved inward, or convex so as to correspond with a concavely curved contour of the ball socket. A transition can be provided between the inner circumferential surface of the annular area facing away from the joint ball and the inner circumferential surface of the annular area facing toward the joint ball. In that way, the transition can realize a conformation between the rotationally-symmetrical inner circumferential surface of the annular area facing toward the joint ball and the non-rotationally-symmetrical inner circumferential surface of the annular area facing away from the joint ball. In particular, the transition is not rotationally-symmetrical.

The annular space and/or the locking ring can have an essentially wedge-like or wedge-shaped cross-section. Alternatively, the annular space and/or the locking ring can have, at least partially, a rectangular cross-section. In particular, the annular space and/or the locking ring has a rectangular cross-section essentially in a plane in the transverse direction. Essentially in a plane in the longitudinal direction, the annular space and/or the locking ring can have a cross-section of a wedge-like shape. In that case the cross-section can have an oblique surface directed transversely to the central axis. The oblique surface is designed such that it extends outward with increasing distance from the mid-point of the joint ball. This gives a conically expanding cross-section of the locking ring in a plane in the longitudinal direction. In that way a larger angular range, in particular in the longitudinal direction, can be produced for the movement of the ball journal. Thus, in the longitudinal direction larger angular deflections can be realized for the ball journal than in the transverse direction. The locking ring can be a flat ring. In particular, the height of the locking ring or flat ring is smaller than the width of the locking ring or flat ring.

Preferably, the annular area facing toward the joint ball has an outer circumferential surface that surrounds the central axis. Advantageously the, or an outer circumferential surface of the annular area facing toward the joint ball is rotation-symmetrical and/or circular and/or circular-cylindrical, in particular relative to the central axis. Preferably, the inner circumferential surface of the annular area facing toward the joint ball tapers with increasing distance from the mid-point of the joint ball. Advantageously, the end face of the locking ring and/or of the annular area facing toward the joint ball lies in an end-face plane extending transversely to the central axis, which for example is also called the inner end-face plane. The above measures are in particular advantageous in themselves or in combination, since the locking ring can press the overlap area of the ball socket against the joint ball in a conventional manner. In particular, a specially designed ball socket and/or a specially designed housing are specifically not necessary for this. Preferably the annular areas of the locking ring are arranged in the axial direction in particular directly one behind the other and/or adjacent to one another and/or one after the other. Advantageously, in the axial direction the annular areas of the locking ring merge into one another.

Preferably, the annular area facing away from the joint ball has an inner circumferential surface that surrounds the central axis. Advantageously, in the longitudinal direction the, or an inner circumferential surface of the annular area facing away from the joint ball has a larger diameter than in the transverse direction. Preferably, the inner circumferential surface of the annular area facing away from the joint ball, for example in the, or in an annular plane extending transversely to the central axis, is oval and/or elliptical and/or in the shape of an elongated hole. Preferably the projection of the inner circumferential surface of the annular area facing away from the joint ball on the, or on a projection plane perpendicular to the central axis is oval and/or elliptical and/or in the shape of an elongated hole. Preferably, the annular area facing away from the joint ball and/or its inner circumferential surface define the locking ring opening and/or the geometry or shape of the locking ring opening and/or the dimensions of the locking ring opening. Preferably, the annular area facing away from the joint ball has an outer circumferential surface that surrounds the central axis. Advantageously, particularly relative to the central axis the, or an outer circumferential surface of the annular area facing away from the joint ball is rotationally-symmetrical and/or circular and/or circular-cylindrical.

Along its circumference the locking ring is for example completely closed. Alternatively the locking ring is made as an open or slotted ring and/or is provided with a slot and/or an interstice. For example, the locking ring is made of wire. Preferably, the locking ring has an integral and/or material-homogeneous and/or monolithic body. Preferably the locking ring is made of metal, in particular a ferrous material such as steel.

According to a further development the overlap area of the ball socket, in particular around the central axis or surrounding the central axis or coaxial with the central axis, is overlapped in the axial direction by the annular area facing toward the joint ball. An overlap of the overlap area of the ball socket going beyond this in the axial direction preferably takes place in, or only in the transverse direction by the annular area facing away from the joint ball, and/or preferably exists in, or only in the transverse direction by the annular area facing away from the joint ball. In particular, this additional overlap exists in an angular range of ±60° perpendicularly to the longitudinal direction. Preferably, the ball socket and/or the overlap area rests on the annular area facing toward the joint ball and/or on its inner circumferential surface in the axial direction. Advantageously, the ball socket and/or the overlap area rests in the transverse direction on the annular area facing away from the joint ball in the axial direction. Preferably, the ball socket also rests in the longitudinal direction on the annular area facing away from the joint ball in the axial direction. In particular, the larger is the overlap area in the transverse direction, the better. The overlap area that exists essentially in the transverse direction, can be larger than the overlap area that exists essentially in the longitudinal direction. In that way larger forces can be absorbed than in the longitudinal direction.

Preferably, the inner surface of the annular area facing away from the joint ball is divided in the transverse direction into two surface zones axially opposite one another, of which a first surface zone faces toward the joint ball and a second surface zone faces away from the joint ball. Preferably, the inner surface of the first surface zone tapers with increasing distance from the mid-point of the joint ball. In particular, the first surface zone forms an extension and/or prolongation of the inner circumferential surface of the annular area facing toward the joint ball. Preferably, in the axial direction and/or in the direction extending away from the joint ball the second surface zone is inclined outward. Advantageously, the inner surface of the annular area facing away from the joint ball is inclined outward in the longitudinal direction relative to the central axis in the axial direction and/or in the direction extending away from the joint ball.

An angular range of the joint and/or of the ball journal can be undesirably restricted by a rim of the housing, particularly a rolled edge. To enable a larger deflection or a larger angular range for the joint and/or the ball journal, the housing rim that defines a housing opening can be displaced relative to the locking ring, outward and/or underneath a height level determined by the locking ring. In particular, preferably in the longitudinal direction and/or in the transverse direction the locking ring forms a stop that limits the angular range for the joint and/or the ball journal. For example, the locking ring can have a step facing away from the joint ball. The rim of the housing can engage in this step of the locking ring.

The housing preferably consists of plastic or metal. For example, the housing consists of a ferrous material such as steel. Advantageously, the housing is shaped rotationally-symmetric or approximately so, in particular relative to the central axis.

The ball journal preferably consists of metal. For example, the ball journal consists of a ferrous material such as steel. Advantageously, relative to a ball journal axis the ball journal is made rotationally-symmetrical or approximately so. Preferably, the ball journal axis passes through the mid-point of the joint ball.

The deflection, or a deflection of the ball journal relative and/or with respect to the housing is in particular characterized or defined by an angle enclosed between the central axis and the ball journal axis. In the undeflected position of the ball journal the ball journal axis preferably coincides with the central axis.

The ball joint is in particular provided for a vehicle, preferably a motor vehicle. Preferably, the ball joint is arranged in the chassis and/or in a wheel suspension and/or in an axle suspension of the vehicle, or of a vehicle. Advantageously, the housing is connected to a first vehicle component and the ball journal is connected to a second vehicle component. In particular the vehicle components are connected, preferably articulated to one another, by means of the ball joint. Preferably, one of the components is in the form of a wheel carrier or steering knuckle. Furthermore, another of the components is preferably in the form of a control arm, specifically a chassis control arm. Preferably, the control arm is a transverse control arm and/or a longitudinal supporting arm. Preferably, the ball joint is a supporting joint.

### BRIEF DESCRIPTION OF THE DRAWINGS

Below, the invention is described with reference to a preferred embodiment and in relation to the drawings, which show:

FIG. 1: A sectioned view of a first embodiment of a ball joint,

FIG. 2: An enlarged view of the area marked A in FIG. 1, with a locking ring,

FIG. 3: The representation as in FIG. 2, but rotated by 90° about a central axis of the ball joint,

FIG. 4: A schematic view of the locking ring, seen from above, and

FIG. 5: A schematic view from above, of a different variant of a locking ring.

### DETAILED DESCRIPTION OF THE PREFERRED EMBODIMENTS

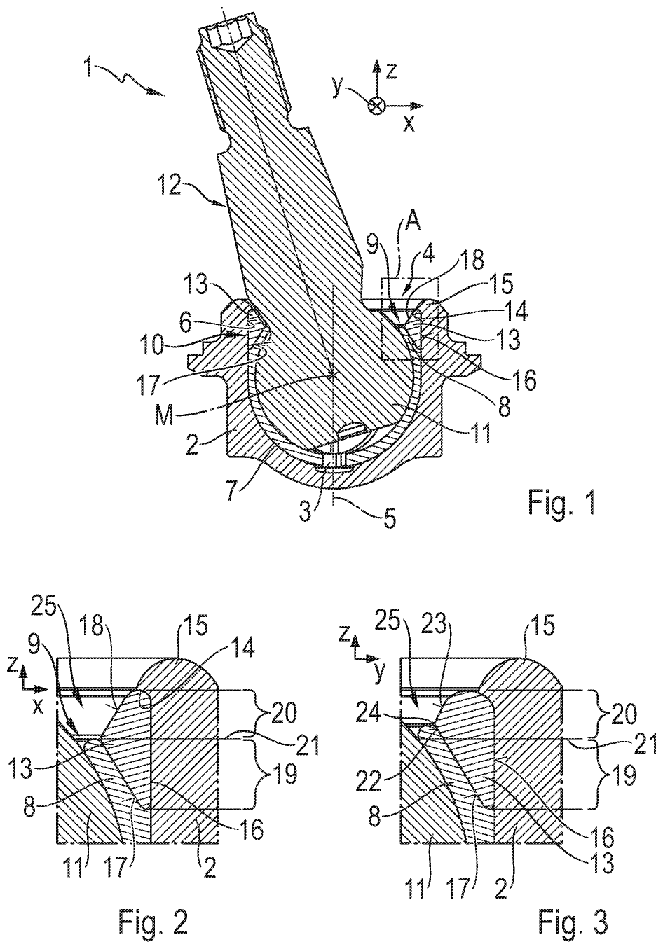

FIG. 1 shows a sectioned view of an embodiment of a ball joint 1, which comprises a housing 2 with an inside space 3 and a housing opening 4, such that in an area facing toward the housing opening 4, the inside space 3 is delimited by a cylindrical inner circumferential surface 6 of the housing 2 that extends around a central axis 5. The central axis 5 extends in an axial direction z. In addition a longitudinal direction x and a transverse direction y are shown, such that the longitudinal direction x extends transversely to the axial direction z and the transverse direction y extends transversely to the axial direction z and to the longitudinal direction x. In FIG. 1 the transverse direction y extends into the plane of the drawing.

In the inside space 3 is arranged a ball socket 7 open toward the housing opening 4, which has an overlap area 8 on its side facing toward the housing opening 4, this overlap area delimiting a ball socket opening 9 of the ball socket 7. Furthermore the overlap area 8 is inclined inward relative to the central axis 5 in the direction of the housing opening 4, and together with the cylindrical inner circumferential surface 6 of the housing 2 delimits an annular space 10. In the ball socket 7 a ball journal 12 with a joint ball 11 is fitted so that the joint ball 11 is able to move by sliding, which journal extends through the ball socket opening 9 and the housing opening 4 out of the housing 2. The mid-point of the joint ball 11 is indexed M.

In the annular space 10 delimited by the overlap area 8 and the cylindrical inner circumferential surface 6 of the housing 2 is fitted a locking ring 13, which is held axially between the ball socket 7 and an inner shoulder 14 of the housing 2 provided in the area of the housing opening 4, the shoulder being formed by a housing rim 15 of the housing 2 that is bent inward. The locking ring 13 is supported on the ball socket 7 on its side facing away from the housing opening 4. Moreover the locking ring 13 is pressed by the inner shoulder 14 axially against the ball socket 7, so that it is held under some prestress. The locking ring 13 has a cylindrical outer circumferential surface 16 that is in contact with the cylindrical inner circumferential surface 6 of the housing 2 and a contact surface 17 which is in contact with the overlap area 8 of the ball socket 7 and is inclined, relative to the central axis 5, inward in the direction of the housing opening 4. Seen in cross-section the surfaces 16 and 17 form a wedge, wherein the cylindrical inner circumferential surface 6 of the housing 2 and the overlap area 8 of the ball socket 7 make the annular space 10 also wedge-shaped in cross-section. The locking ring 13 also has a free opening surface 18 facing toward the housing opening 4 and inclined outward relative to the central axis 5 in the direction of the housing opening 4. An enlarged view of the area indexed A in FIG. 1 is shown in FIG. 2.

As can be seen particularly clearly in FIG. 2, the locking ring 13 can be divided into a first annular area 19 facing toward the joint ball 11 and a second annular area 20 facing away from the joint ball 11 the annular areas 19 and 20 being in each case ring-shaped and merging into one another at a transition 21 in the axial direction z. The transition 21 is formed by the transition from the contact surface 17 to the opening surface 18 as shown in FIGS. 1 and 2. In this case the contact surface 17 forms an inner circumferential surface of the first annular area 19 and is rotation-symmetrical relative to the central axis 5. In contrast, the inner circumferential surface of the second annular area 20 extending around the central axis 5 is larger in the longitudinal direction x than in the transverse direction y.

FIGS. 1 and 2 show sectioned views of the ball joint in the z-x plane, whereas in contrast FIG. 3 shows the view according to FIG. 2 but in the y-z pane. According to FIG. 2 the inner surface of the second annular area 20 is formed by the opening surface 18, whereas in contrast, according to FIG. 3 the inner surface of the second annular area 20 is formed by surface areas 22 and 23, of which surface area 22 is referred to as the inner surface area and surface area 23 is referred to as the outer surface area. In this case the inner surface area 22 faces toward the joint ball whereas the outer surface area 23 faces away from the joint ball 11. Furthermore, the surface areas 22 and 23 merge into one another in the axial direction z at a transition 24.

From FIG. 3 it can be seen that starting from the first annular area 19, the inner surface of the second annular area 20 first tapers in the inner surface area 22 with increasing distance from the mid-point M of the joint ball 11 and is only inclined outward relative to the central axis 5 at an axial distance from the first annular area 19 in the outer surface area 23. Here, the surface area 22 forms an extension and/or prolongation of the contact surface 17 of the first annular area 19. Thus, by means of the surface area 22 and the contact surface 17, a supporting area for the joint ball 11 is formed, which in the transverse direction y is larger than a supporting area consisting exclusively of the contact surface 17 in the longitudinal direction x as in FIG. 2.

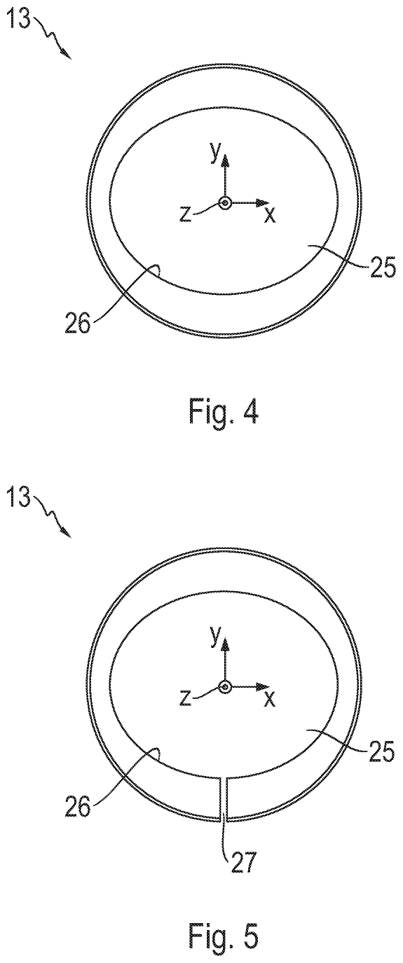

Thus, at the transition 24 between the surface areas 22 and 23 the distance of the locking ring 13 from the central axis 5 is smaller than at the transition 21, so that the projection of the locking ring opening 25 delimited by the locking ring 13 onto a plane extending transversely to the central axis 5 forms an oval area. This can be seen in FIG. 4, which shows a schematic view of the locking ring 13 as seen from above.

The locking ring opening 25 is larger in the longitudinal direction x than in the transverse direction y. In this case the inner circumferential line 26 of the closure opening, viewed from above in FIG. 4, does not lie in a plane but in the longitudinal direction x is a smaller axial distance away from the mid-point M of the joint ball 11 than in the transverse direction y. Furthermore, the axial overlapping of the joint ball 11 by the locking ring 13 in the transverse direction y is larger than in the longitudinal direction x. Because of this, however, the ball journal 12 can be deflected farther relative to the housing 2 in the longitudinal direction x than in the transverse direction y.

FIG. 5 shows a schematic view of a locking ring 13 according to a variant, wherein the locking ring 13 has a slot 27 and is in the form of a split or open ring. Apart from this difference the locking ring according to FIG. 5 is identical to the locking ring according to FIGS. 1 to 4, so that for a more detailed description of the locking ring in FIG. 5 reference should be made to the locking ring according to FIGS. 1 to 4. In particular, the locking ring of FIG. 5 can be used in place of the locking ring according to FIGS. 1 to 4.

In this example embodiment the slot 27 is directed perpendicularly to the longitudinal direction x, or along the transverse direction y. In alternative embodiments the slot 27 can be arranged in any other position, for example transversely to the longitudinal direction x and/or transversely to the transverse direction y.

### INDEXES

1 Ball joint
2 Housing of the ball joint
3 Inside space of the housing
4 Housing opening
5 Central axis of the housing
6 Inner circumferential surface of the housing
7 Ball socket
8 Overlap area of the ball socket
9 Ball socket opening
10 Annular space
11 Joint ball of the ball joint
12 Ball journal
13 Locking ring
14 Inner shoulder
15 Rim of the housing
16 Outer circumferential surface of the locking ring
17 Contact area of the locking ring
18 Opening area of the locking ring
19 First annular area of the locking ring
20 Second annular area of the locking ring
21 Transition between the annular areas
22 Inner surface area of the second annular area
23 Outer surface area of the second annular area
24 Transition between the surface areas
25 Locking ring opening
26 Inner circumferential line
27 Slot
x Longitudinal direction
y Transverse direction
z Axial direction
M Mid-point of the joint ball

1-10. (canceled)

11. A ball joint comprising:
a housing (2) having a housing opening (4) with which a central axis (5) is associated,
the central axis extending in an axial direction (z) and emerging through the housing opening (4),
a ball journal (12) having a joint ball (11) which, with the joint ball (11), is fitted and movable within the housing (2) and which extends out of the housing through the housing opening (4),
a locking ring (13) being fitted securely into the housing (2) and which surrounds the central axis (5) and supports the joint ball (11) in the axial direction (z),
the locking ring delimiting a locking ring opening (25) through which the ball journal (12) extends, and
the locking ring opening (25) being larger in a longitudinal direction (x), that extends transversely to the central axis (5), than in a transverse direction (y), that extends transversely to the central axis (5) and to the longitudinal direction (x).

12. The ball joint according to claim 11, wherein the locking ring opening (25) is one of oval, elliptical or in a shape of an elongated hole.

13. The ball joint according to claim 11, wherein an outer circumferential surface (16) of the locking ring is rotationally-symmetrical relative to the central axis.

14. The ball joint according to claim 11, wherein the locking ring (13) has a circular-cylindrical outer circumferential surface (16).

15. The ball joint according to claim 11, wherein an end-face of the locking ring (13) facing away from the joint ball (11) lies in an end-face plane that extends transversely to the central axis (5).

16. The ball joint according to claim 11, wherein the locking ring (13) overlaps the ball joint (11) in the axial direction (z).

17. The ball joint according to claim 11, wherein the joint ball (11) is fitted into the housing (2) with interposition of a ball socket (7) which has a ball socket opening (9) and an overlap area (8) that delimits the ball socket opening (9), the overlap area overlaps the joint ball (11), in the axial direction (z), and is overlapped, in the axial direction (z), by the locking ring (13), and the ball journal (12) extends out through the ball socket opening (9).

18. The ball joint according to claim 11, wherein the locking ring (13) comprises an annular area (20) facing away from the joint ball (11) and an annular area (19) facing toward the joint ball (11), the locking ring has, relative to the central axis (5), a rotationally-symmetrical inner circumferential surface (17), an inner circumferential surface (22) of the annular area (20), facing away from the joint ball (11), has a larger diameter, in the longitudinal direction (x), than in the transverse direction (y), and there is a transition (24) between the inner circumferential surface (22) of the annular area (20) facing away from the joint ball (11) and the inner circumferential surface (17) of the annular area (19) facing toward the joint ball (11).

19. The ball joint according to claim 17, wherein the overlap area (8) of the ball socket (7) is overlapped around the central axis (5), in the axial direction (z), by an annular area (19) of the locking ring (13) facing toward the joint ball (11), and an additional overlap of the overlap area (8) of the ball socket (7), in the axial direction (z), only exists in the transverse direction (y), in an angular range of ±60° perpendicularly to the longitudinal direction (x), by an annular area (20) of the locking ring (13) facing away from the joint ball (11).

20. The ball joint according to claim 18, wherein the inner circumferential surface (17) of the annular area (19) facing toward the joint ball (11) tapers with increasing distance from a mid-point (M) of the joint ball (11).

21. A ball joint comprising:
a housing comprising a housing opening and defining a central axis that extends in an axial direction and passes centrally through the housing opening;
a ball journal having a joint ball which being movably fitted within the housing such that the ball journal extends out of the housing through the housing opening;
a locking ring being mounted securely into the housing such that the locking ring surrounds the central axis and is at least substantially perpendicular to the central axis, and
the locking ring fixing the joint ball in the axial direction within the housing, the locking ring delimiting a locking ring opening through which the ball journal extends, the locking ring opening being larger, in a longitudinal direction, than in a transverse direction, the longitudinal direction extending transversely to the central axis, and the transverse direction extending transversely to the central axis and the longitudinal direction.
